(19) United States
(12) Patent Application Publication
(10) Pub. No.: US 2022/0036174 A1
(43) Pub. Date: Feb. 3, 2022

(54) MACHINE LEARNING HYPER TUNING

(71) Applicant: Dell Products L.P., Round Rock, TX (US)

(72) Inventor: Ally Junio Oliveira BARRA, Cork (IE)

(73) Assignee: Dell Products L.P., Round Rock, TX (US)

(21) Appl. No.: 16/943,922

(22) Filed: Jul. 30, 2020

(51) Int. Cl. G06N 3/08; G06N 3/04

(52) U.S. Cl. CPC G06N 3/08; G06N 3/04

(57) ABSTRACT

An information handling system may include at least one processor; and a non-transitory memory coupled to the at least one processor. The information handling system may be configured to: communicatively couple to a cloud platform for execution of a machine learning task; and cause the cloud platform to execute a hyper server that is configured to: determine a plurality of sets of possible values for hyperparameters of the machine learning task; for each of the plurality of sets of possible values, dispatch a model comprising the set to a hyper client configured to execute a model training process based on the set; receive, for each set, statistics relating to the model training process for the set; and determine, based on the received statistics, a particular set that is preferred.

### TECHNICAL FIELD

The present disclosure relates in general to information handling systems, and more particularly to the management of machine learning systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCl) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCl solution is the Dell EMC VxRail™ system. Some examples of HCl systems may operate in various environments (e.g., an HCl management system such as the VMware® vSphere® ESXi™ environment, or any other HCl management system).

Various embodiments of this disclosure may be applied in the field of HCl systems. Further, some embodiments of this disclosure may be implemented using one or more cloud platforms such as Pivotal Cloud Foundry (PCF), etc. Examples may also be described in terms of the Python programming language. One of ordinary skill in the art with the benefit of this disclosure will readily appreciate that other embodiments may use different toolchains.

Some embodiments of this disclosure may employ artificial intelligence (AI) techniques such as machine learning, deep learning, natural language processing (NLP), etc. Generally speaking, machine learning encompasses a branch of data science that emphasizes methods for enabling information handling systems to construct analytic models that use algorithms that learn interactively from data. It is noted that, although disclosed subject matter may be illustrated and/or described in the context of a particular AI paradigm, such a system, method, architecture, or application is not limited to those particular techniques and may encompass one or more other AI solutions.

In the creation of a machine learning model, many design choices may arise as to how to define the model architecture. Often, it is not known a priori what the optimal model architecture should be for a given model, and thus it would be advantageous to be able to explore a range of possibilities. According to some embodiments, machine learning techniques may be leveraged to perform this exploration and select the optimal model architecture automatically. Parameters that define the model architecture are referred to herein as hyperparameters, and thus this process of searching for the ideal model architecture (e.g., choosing a set of optimal hyperparameters for a learning algorithm) is referred to as hyperparameter tuning or hyper tuning.

For purposes of this disclosure, a hyperparameter is a parameter that has a value which is set before the learning process begins. Some non-limiting examples of hyperparameters may include penalty in logistic regression and loss in stochastic gradient descent.

Hyperparameters might address model design questions such as:

1. What degree of polynomial features should be used for a linear model?

2. What should be the maximum depth allowed for a decision tree?

3. What should be the minimum number of samples required at a leaf node in a decision tree?

4. How many trees should be included in a random forest?

5. How many neurons should be included in a neural network layer?

6. How many layers should be included in a neural network?

7. What should be the learning rate for gradient descent?

Even for relatively simple algorithms like linear regression, it can be difficult to find the best set for the hyperparameters. With more complicated algorithms like deep learning, it is much more difficult.

Some non-limiting examples of parameters to tune when optimizing neural nets (NNs) may include: learning rate, momentum, regularization, dropout probability, batch normalization, and number of hidden units.

Accordingly, embodiments of this disclosure may provide improvements in the determination of hyperparameters used in machine learning.

It should be noted that, although this disclosure describes the example of HCl systems and PCF in detail for the sake of clarity and exposition, various aspects of this disclosure may in some embodiments be applied to traditional datacenters, individual compute/storage/networking devices, virtual machines, etc.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with the management of machine learning systems may be reduced or eliminated.

In accordance with embodiments of the present disclosure, an information handling system may include at least one processor; and a non-transitory memory coupled to the at least one processor. The information handling system may be configured to: communicatively couple to a cloud platform for execution of a machine learning task; and cause the cloud platform to execute a hyper server that is configured to: determine a plurality of sets of possible values for hyperparameters of the machine learning task; for each of the plurality of sets of possible values, dispatch a model comprising the set to a hyper client configured to execute a model training process based on the set; receive, for each set, statistics relating to the model training process for the set; and determine, based on the received statistics, a particular set that is preferred.

In accordance with these and other embodiments of the present disclosure, a method may include an information handling system communicatively coupling to a cloud platform for execution of a machine learning task; and the information handling system causing the cloud platform to execute a hyper server that is configured to: determine a plurality of sets of possible values for hyperparameters of the machine learning task; for each of the plurality of sets of possible values, dispatch a model comprising the set to a hyper client configured to execute a model training process based on the set; receive, for each set, statistics relating to the model training process for the set; and determine, based on the received statistics, a particular set that is preferred.

In accordance with these and other embodiments of the present disclosure, an article of manufacture may include a non-transitory, computer-readable medium having computer-executable code thereon that is executable by an information handling system for: communicatively coupling to a cloud platform for execution of a machine learning task; and causing the cloud platform to execute a hyper server that is configured to: determine a plurality of sets of possible values for hyperparameters of the machine learning task; for each of the plurality of sets of possible values, dispatch a model comprising the set to a hyper client configured to execute a model training process based on the set; receive, for each set, statistics relating to the model training process for the set; and determine, based on the received statistics, a particular set that is preferred.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIGS. 2A-2B illustrate examples of grid search and random search for machine learning parameters, in accordance with embodiments of the present disclosure;

FIG. 3 illustrates an example method, in accordance with embodiments of the present disclosure;

FIG. 4 illustrates an example schema for a workflow task, in accordance with embodiments of the present disclosure; and

FIGS. 5A-5C illustrate example methods, in accordance with embodiments of the present disclosure.

### DETAILED DESCRIPTION

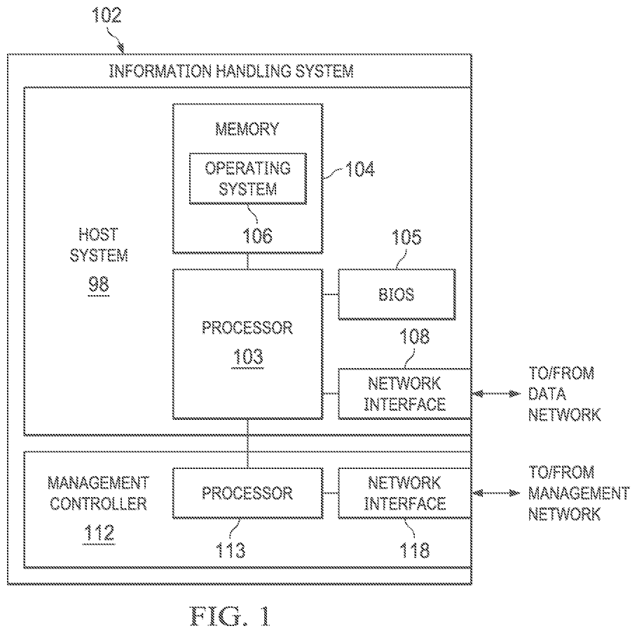

Preferred embodiments and their advantages are best understood by reference to FIGS. 1 through 5C, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102 (e.g., by a user operating a management console). Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may provide improvements in the determination of hyperparameters used in machine learning.

In one possible solution, a grid search technique may be used, typically when only a small number of parameters (e.g., two or three) need to be optimized. In the grid search embodiment, for each hyperparameter, a set of candidate values to explore may be defined. Then, every possible combination of the values of the individual parameters may be exhaustively tried.

For each combination, a different model may be trained and evaluated. The model with the smallest generalization error may be selected as having the best hyperparameters.

A problem with grid search, however, is that it is an exponential time algorithm. Its computational cost grows exponentially with the number of parameters. In other words, if there are p parameters to be optimized, and each one takes at most v values, then exhaustive grid search may require O(v^{p}) time.

Further, grid search may not be sufficiently effective in exploring the hyperparameter space. For example, a list of values may be defined to try for both n_estimators and max_depth, and a grid search may build a model for each possible combination. The hyperparameter space may be defined as:
n_estimators=[10, 50, 100, 200]
max_depth=[3, 10, 20, 40]

Performing grid search over the defined hyperparameter space may yield the following models:
RandomForestClassifier(n_estimators=10, max_depth=3)
RandomForestClassifier(n_estimators=10, max_depth=10)
RandomForestClassifier(n_estimators=200, max_depth=40)

Each model may be fit to the training data and evaluated on the validation data. This is an exhaustive sampling of the hyperparameter space, and it may be too inefficient in many situations.

Another possible solution involves random search, which differs from grid search mainly in that it searches the specified subset of hyperparameters randomly instead of exhaustively. The major benefit of random search over grid search is decreased processing time.

As one example, a sampling distribution for each hyperparameter may be defined:
from scipy.stats import expon as sp_expon
from scipy.stats import randint as sp_randint
n_estimators=sp_expon(scale=100)
max_depth=sp_randint(1, 40)

A number of iterations may also be defined to determine how many iterations to build when searching for the optimal model. For each iteration, the hyperparameter values of the model may be set by sampling the distributions defined above.

One of the theoretical backings that may motivate the use of random search in place of grid search is that it is believed that, for most cases, hyperparameters are not equally important.

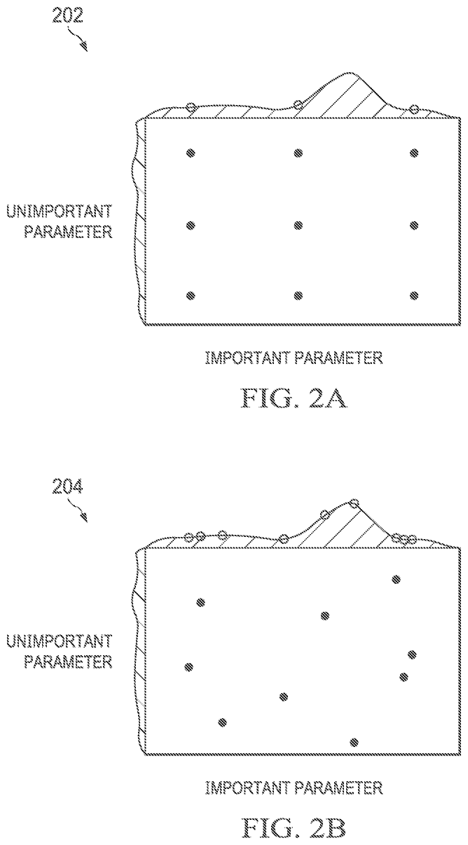

Turning now to FIG. 2 (which includes FIGS. 2A-2B), an example is shown that involves searching over a hyperparameter space where one hyperparameter has significantly more influence on optimizing the model score. The distributions shown on each axis represent the model's score. Layout 202 illustrates a grid search of this parameter space, and layout 204 illustrates a random search of this parameter space. For the sake of simplicity and exposition, FIG. 2 illustrates the effects of each parameter while holding the other constant. In actual practice, however, a three-dimensional landscape to illustrate the combined effects would be more appropriate.

In both layout 202 and layout 204, nine different models are evaluated having parameters selected from the parameter space as shown. The grid search strategy in layout 202 misses the optimal model and spends redundant time exploring the unimportant parameter.

During the grid search of layout 202, each hyperparameter is isolated, and the best possible value is determined while holding all other hyperparameters constant. For cases where the hyperparameter being studied has little effect on the resulting model score, this results in wasted effort. Conversely, the random search shown in layout 204 has much improved exploratory power and can focus on finding the optimal value for the important hyperparameter.

The random search method typically works best under the assumption that not all hyperparameters are equally important. While this isn't always the case, the assumption is believed to hold true for many datasets encountered in practice.

According to some embodiments, hyperparameter tuning may work by running multiple trials in a single hyper client app. Each trial may be a complete execution of the training application with values for the chosen hyperparameters, set within limits that a user may specify. The hyper server app may keep track of the results of each trial and make adjustments for subsequent trials. When the job is finished, the process may provide a summary of all the trials along with the most effective configuration of values according to the criteria specified.

Hyperparameters may contain the data that governs the training process itself. The training application may handle three categories of data as it trains a model:
1. The input data (also called training data) is a collection of individual records (instances) containing the features that are important to the machine learning problem. This data may be used during training to configure the model to accurately make predictions about new instances of similar data. However, the values in the input data typically do not directly become part of the model.
2. The model's parameters are the variables that the chosen machine learning technique uses to adjust to the data. For example, a deep neural network (DNN) is composed of processing nodes (neurons), each with an operation performed on data as it travels through the network. When the DNN is trained, each node has a weight value determines how much impact it has on the final prediction. Those weights are an example of the model's parameters. In many ways, the model's parameters can be considered to be the model itself: they are what distinguishes a particular model from other models of the same type working on similar data.
3. The hyperparameters are the variables that govern the training process itself. For example, part of setting up a deep neural network is deciding how many hidden layers of nodes to use between the input layer and the output layer, and how many nodes each layer should use. These variables are not directly related to the training data, but are configuration variables. In particular, parameters may change during a training job, while hyperparameters are usually constant during a job.

The model parameters may be optimized/tuned by the training process: data is run through the operations of the model, the resulting prediction with the actual value for each data instance is compared, the accuracy is evaluated, and the parameters are adjusted until the best values are found. Hyperparameters may be tuned by running the complete training job, looking at the aggregate accuracy, and adjusting. In both cases, the composition of the model is modified in an effort to find the best combination to handle the problem at hand.

Without an automated technology such as an embodiment of the present disclosure, it may be necessary to make manual adjustments to the hyperparameters over the course of many training runs to arrive at the optimal values. Hyperparameter tuning according to the present disclosure makes the process of determining the best hyperparameter settings easier, less tedious, and more efficient.

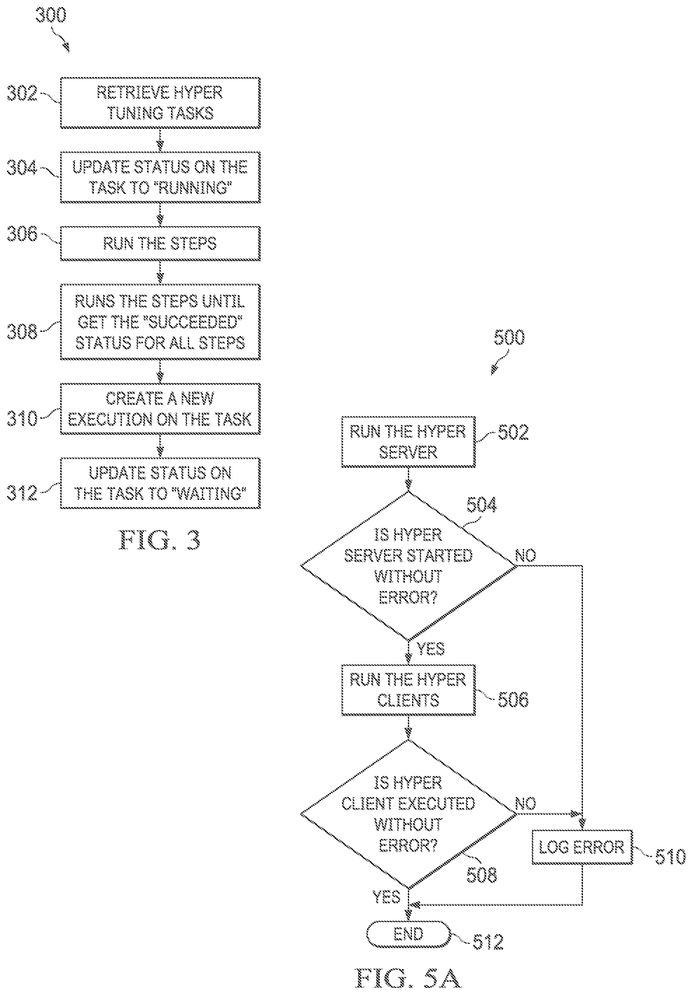

Turning now to FIG. 3, a flow chart is shown of an example method 300 for operating a machine learning hyper tuning system, in accordance with some embodiments of this disclosure. At step 302, one or more hyper tuning tasks may be retrieved by the system. At step 304, a status flag or variable for the task may be updated to a “running” status.

At step 306 and 308, the steps of the task are run until all steps have the “succeeded” status.

At step 310, a new execution entry for the task may be created. At step 312, the status of the task may be updated to “waiting.” After step 312, the method may end.

One of ordinary skill in the art with the benefit of this disclosure will understand that the preferred initialization point for the method depicted in FIG. 3 and the order of the steps comprising that method may depend on the implementation chosen. In these and other embodiments, this method may be implemented as hardware, firmware, software, applications, functions, libraries, or other instructions. Further, although FIG. 3 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

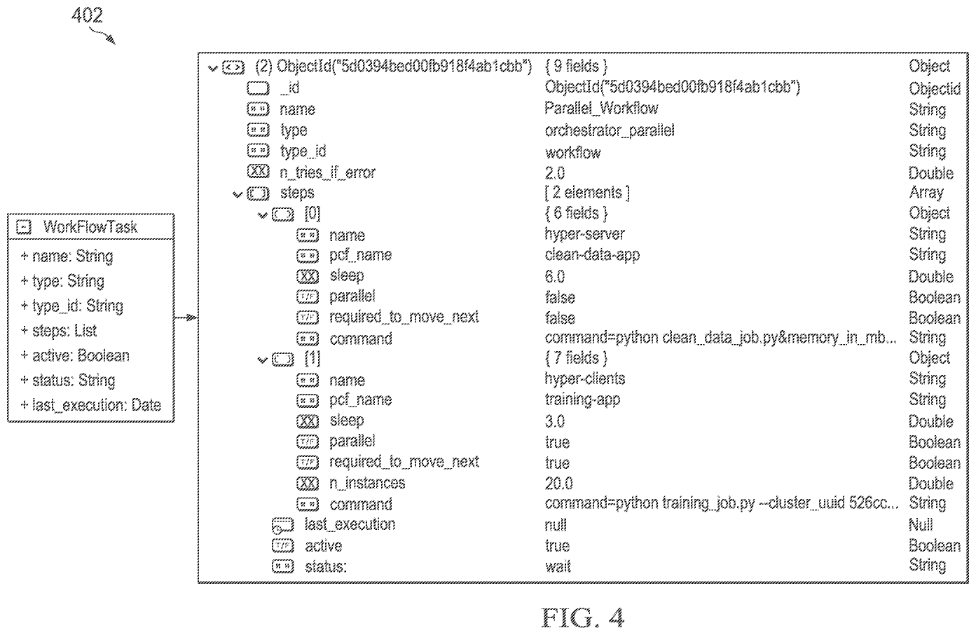

Turning now to FIG. 4, an example schema 402 for a workflow task is shown. One of ordinary skill in the art with the benefit of this disclosure will appreciate that the data illustrated in FIG. 4 is merely one example of the types of data that might be included in such a schema.

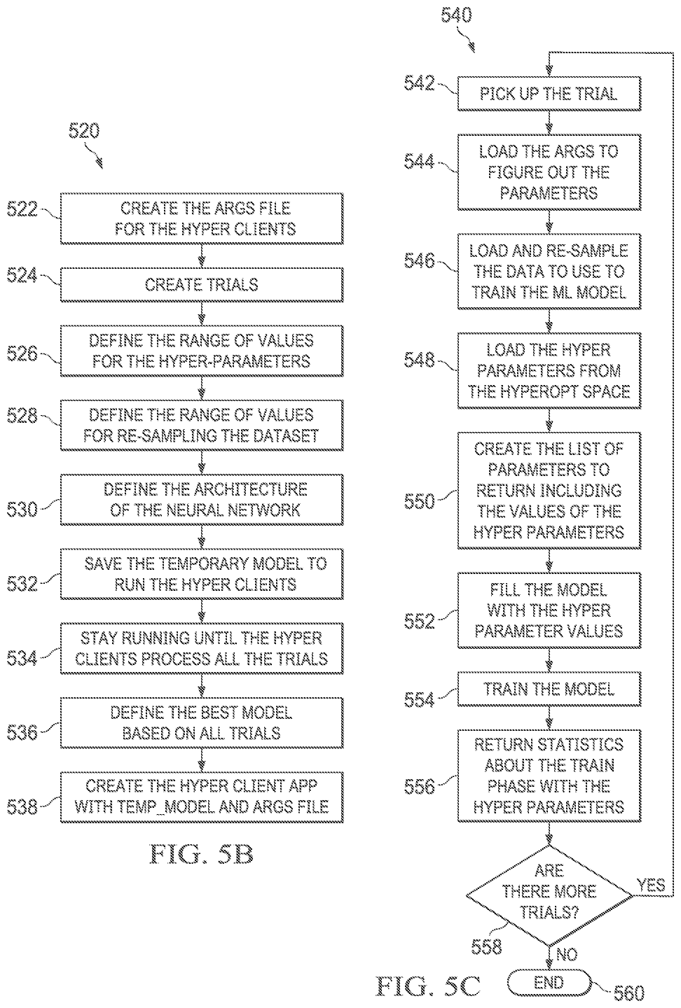

Turning now to FIG. 5 (which includes FIGS. 5A-5C), flow charts are shown of example methods for operating a machine learning hyper tuning system, in accordance with some embodiments of this disclosure. The system may include two main components: the hyper tuning server that creates the group of possible values for the parameters, and the hyper tuning client, each instance of which takes a possible set of values and executes with them. The client may save the result at the end of each execution, and after executing all the possibilities, the server may choose the best set of parameters. FIG. 5A illustrates the overall process, while FIG. 5B illustrates the hyper tuning server, and FIG. 5C illustrates the hyper tuning client.

In FIG. 5A, method 500 may begin at step 502, in which the hyper server is initialized. At step 504, if the hyper server starts without error, the method may proceed to step 506 to initialize one or more hyper clients. If the hyper clients start without error, the method may end at step 512.

If errors are encountered at step 504 and/or step 508, an error may be logged at step 510 (e.g., by sending an email to a user of the hyper tuning system), and the method may then end at step 512.

In FIG. 5B, method 520 for a hyper tuning server may begin at step 522, in which an arguments file is created for the hyper clients to use. At step 524, one or more trials may be created.

At step 526, the range of values for the hyperparameters may be defined (e.g., based on user input). At step 528, a range of values may also be defined for re-sampling of the dataset.

At step 530, an architecture for the neural network may be defined. At step 532, the temporary model may be saved for the hyper clients to run.

The hyper server remains running at step 534 until all hyper clients have finished processing the trials.

At step 536, based on statistics returned by the hyper clients, the hyper server may define the best model based on all of the trials that have been executed. In some embodiments, the statistics may comprise a generalization error, and the best model may be the one with the smallest generalization error. In other embodiments, different types of statistics may also be used.

At step 538, the hyper server may create the hyper client app with the temporary model and the arguments file. After step 538, the hyper server method may end.

In FIG. 5C, method 540 for a hyper tuning client may begin at step 542, in which the client may retrieve a trial from the hyper server. At step 544, the client may load the arguments file from the server to determine the parameters that are to be tested.

At step 546, the hyper client may load and re-sample the data that is to be used to train the machine learning model. At step 548, the hyper client may load the hyper parameters. In embodiments using Python, the hyper parameters may be loaded via a library such as hyperopt.

At step 550, the hyper client may create a list of parameters to return, which may include the values of the hyperparameters.

At step 552, the model may be filled based on the hyperparameter values, and at step 554, the model may be trained.

At step 556, the hyper client may return statistics to the hyper server about the trial phase with the particular hyperparameters.

At step 558, the method may loop until no more trials remain. At step 560, the method may end.

One of ordinary skill in the art with the benefit of this disclosure will understand that the preferred initialization point for the method depicted in FIG. 5 and the order of the steps comprising that method may depend on the implementation chosen. In these and other embodiments, this method may be implemented as hardware, firmware, software, applications, functions, libraries, or other instructions. Further, although FIG. 5 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

Thus embodiments of this disclosure may provide many benefits over existing systems. By creating a hyper server and running multiple hyper clients in parallel, embodiments may deliver the best combination of hyperparameters in a fast, efficient and reliable manner. Without such embodiments, there would be a manual process of setting the hyperparameters for each trial and recording each set used so as not to repeat them. This would be a slow, inefficient process that would not guarantee the best combination of hyperparameters.

Further, some embodiments may achieve better results by resampling the data as part of one variable in the network. Some networks may return better results when the frequency in the data is changed. Thus resampling the data is one variable that may be changed in each cycle like the other hyperparameters.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a non-transitory memory coupled to the at least one processor;
wherein the information handling system is configured to:
communicatively couple to a cloud platform for execution of a machine learning task; and
cause the cloud platform to execute a hyper server that is configured to:
determine a plurality of sets of possible values for hyperparameters of the machine learning task;
for each of the plurality of sets of possible values, dispatch a model comprising the set to a hyper client configured to execute a model training process based on the set;
receive, for each set, statistics relating to the model training process for the set; and
determine, based on the received statistics, a particular set that is preferred.

2. The information handling system of claim 1, wherein the machine learning task is a deep learning task.

3. The information handling system of claim 1, wherein the model comprises a neural network.

4. The information handling system of claim 3, wherein the hyperparameters include a learning rate, a momentum, a regularization, a dropout probability, a batch normalization, and a number of hidden units.

5. The information handling system of claim 1, wherein the statistics include a generalization error.

6. The information handling system of claim 5, wherein the particular set that is preferred is associated with a smallest generalization error.

7. A method comprising:
an information handling system communicatively coupling to a cloud platform for execution of a machine learning task; and
the information handling system causing the cloud platform to execute a hyper server that is configured to:
determine a plurality of sets of possible values for hyperparameters of the machine learning task;
for each of the plurality of sets of possible values, dispatch a model comprising the set to a hyper client configured to execute a model training process based on the set;
receive, for each set, statistics relating to the model training process for the set; and
determine, based on the received statistics, a particular set that is preferred.

8. The method of claim 7, wherein the machine learning task is a deep learning task.

9. The method of claim 7, wherein the model comprises a neural network.

10. The method of claim 9, wherein the hyperparameters include a learning rate, a momentum, a regularization, a dropout probability, a batch normalization, and a number of hidden units.

11. The method of claim 7, wherein the statistics include a generalization error.

12. The method of claim 11, wherein the particular set that is preferred is associated with a smallest generalization error.

13. An article of manufacture comprising a non-transitory, computer-readable medium having computer-executable code thereon that is executable by an information handling system for:
communicatively coupling to a cloud platform for execution of a machine learning task; and
causing the cloud platform to execute a hyper server that is configured to:
determine a plurality of sets of possible values for hyperparameters of the machine learning task;
for each of the plurality of sets of possible values, dispatch a model comprising the set to a hyper client configured to execute a model training process based on the set;
receive, for each set, statistics relating to the model training process for the set; and
determine, based on the received statistics, a particular set that is preferred.

14. The article of claim 13, wherein the machine learning task is a deep learning task.

15. The article of claim 13, wherein the model comprises a neural network.

16. The article of claim 15, wherein the hyperparameters include a learning rate, a momentum, a regularization, a dropout probability, a batch normalization, and a number of hidden units.

17. The article of claim 13, wherein the statistics include a generalization error.

18. The article of claim 17, wherein the particular set that is preferred is associated with a smallest generalization error.
